(19) United States
(12) Patent Application Publication
(10) Pub. No.: US 2009/0158434 A1
(43) Pub. Date: Jun. 18, 2009

(54) Method of detecting virus infection of file

(75) Inventor: In Seon Yoo, Yangju-Si (KR)

Correspondence Address: WELLS ST. JOHN P.S., 601 W. FIRST AVENUE, SUITE 1300, SPOKANE, WA, 99201, US

(73) Assignee: Samsung S.D.S. Co., Ltd.

(21) Appl. No.: 12/077,614

(22) Filed: Mar. 20, 2008

(30) Foreign Application Priority Data
Dec. 18, 2007 (KR) 10-2007-0133545

(51) Int. Cl. G06F 17/00; G06F 15/18

(52) U.S. Cl. 726/24

(57) ABSTRACT

Provided is a method of detecting virus infection of a file. The method includes the steps of a) copying an original file, and converting and simplifying data of the copied file; b) normalizing the simplified file data; c) acquiring distribution of similarity between data using the normalized file data; and d) analyzing the acquired distribution of similarity between data, and determining that the file is virus-infected when a preset dense distribution pattern exists. Thus, the method can effectively determine whether or not the file is infected with a virus without using a database (DB) of spam filtering or virus information.

### BACKGROUND OF THE INVENTION

1. Field of the Invention

The present invention relates, in general, to a method of detecting virus infection of a file and, more particularly, to a method of detecting virus infection of a file, which is capable of effectively determining whether or not the file is infected with a virus without using a database (DB) of spam filtering or virus information.

2. Description of the Related Art

Generally, antivirus technologies can detect the virus only by analyzing the virus after it has caused damage, finding its signature, and updating the results to a database (DB) of virus signatures.

Also, when a variant of the previously created virus causes damage, the variant virus is analyzed again, and then its signature must be updated to the DB as well.

In this manner, the fact that the antivirus technologies depend on the virus signature DB means that they are unable to protect against new viruses or variant viruses until the DB is updated. Thus, there is a need for technology capable of detecting viruses without depending on the DB, for the purpose of prior protection against damage from the viruses.

As described above, since the known antivirus technologies depend on the virus signature DB, when a virus that is not in the DB enters, they are unable to detect it.

Further, the virus signature must be continuously updated to the DB. In this case, the DB can only continue to increase in size. As a result, due to the size of the DB, it is impossible to cope with a demand for light weight.

In other words, the existing methods use a follow-up method that, after the damage resulting from the virus occurs, analyzes the virus to make a corresponding virus signature, making it unsuitable for protection against a new virus.

### SUMMARY OF THE INVENTION

Accordingly, the present invention has been made keeping in mind the above problems occurring in the related art, and an object of the present invention is to provide a method of detecting virus infection of a file, which, as opposed to an existing method of detecting the virus depending on information on virus signatures, determines whether or not the file is infected with a virus by itself using an artificial intelligent method involving distribution of similarity between data without virus information, thereby effectively processing the virus for the purpose of prior protection before damage is caused by the virus, and which can effectively detect a variant of the virus that has already caused damage, thereby reducing damage resulting from this virus to the maximum extent.

In order to achieve the above object, according to one aspect of the present invention, there is provided a method of detecting virus infection of a file, which includes the steps of a) copying an original file, and converting and simplifying data of the copied file; b) normalizing the simplified file data; c) acquiring distribution of similarity between data using the normalized file data; and d) analyzing the acquired distribution of similarity between data, and determining that the file is virus-infected when a preset dense distribution pattern exists.

Step a) may include checking according to a format of the copied file whether or not a file header is deliberately changed prior to converting and simplifying the data of the copied file.

Step a) may include checking a format of the copied file prior to converting and simplifying the data of the copied file, and determining the file to be virus-infected when a part changed deliberately by the virus exists.

The data conversion in step a) may be performed by converting binary format file data into simple integer format file data.

The original file may include one of a general file and an executable file.

The original file may already exist in a user terminal or may be received from an outside source through a specific path.

The user terminal may include one selected from a desktop computer, a laptop computer, a personal digital assistant (PDA), a mobile phone, a WebPDA, and a transmission control protocol (TCP) networking assisted wireless mobile device.

The specific path may include one selected from Internet, e-mail, Bluetooth, and ActiveSync.

Step b) may include converting the simplified file data into data having a specific range when standardized.

In step c), the distribution of similarity between data may be acquired by constituting a code map optimized for the normalized file data using a typical Self-Organizing Map (SOM) learning algorithm, and forming a new matrix on the basis of average values of surrounding values.

Step c) may include the sub-steps of c-1) acquiring median values and eigenvectors of the normalized file data, and constituting a code map using the acquired median values and eigenvectors; c-2) calculating difference values with the normalized file data using the constituted code map, and acquiring best match data vectors; c-3) shifting the code map to another code map in order to calculate whole data once again using the acquired best match data vectors, recalculating difference values with the normalized file data using the shifted another code map, and storing values corresponding to best matched values; and c-4) rearranging the data on the basis of the average values of the surrounding values, and forming a new matrix.

According to another aspect of the present invention, there is provided a computer readable medium recording a program that can execute the method of detecting virus infection of a file using a computer.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A and 1B are views illustrating virus-infected parts of general and executable files, which are applied to an exemplary embodiment of the present invention;

FIG. 2 is a schematic flow chart illustrating a method of detecting virus infection of a file according to an exemplary embodiment of the present invention;

FIG. 3 is a detailed flow chart illustrating a method of acquiring distribution of similarity between data that is applied to an exemplary embodiment of the present invention;

FIGS. 4A through 4E illustrate actual data of a virus-infected file that is determined by a method of detecting virus infection of a file according to an exemplary embodiment of the present invention; and

FIG. 5 illustrates actual data of a dense distribution pattern that is applied to an exemplary embodiment of the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

First, a method of detecting virus infection of a file according to an exemplary embodiment of the present invention can effectively determine whether or not the file is infected with a virus, which enters into any internal user terminal (e.g. a desktop computer, a laptop computer, a personal digital assistant (PDA), a mobile phone, a WebPDA, or a transmission control protocol (TCP) networking assisted wireless mobile device) from an outside source through any path, whether it be received through a Bluetooth, downloaded through the Internet, or received through an ActiveSync.

In this manner, when internal files are infected with the virus due to the file received from the outside source, the method can effectively determine whether the internal files are infected with the virus.

Meanwhile, the virus infection of the file(s) can be divided into two types: one is macro virus infection in which a general file such as an MS Word file or an Excel file is infected; and the other is virus infection in which an executable file ending with a “com” or “exe” extension is infected.

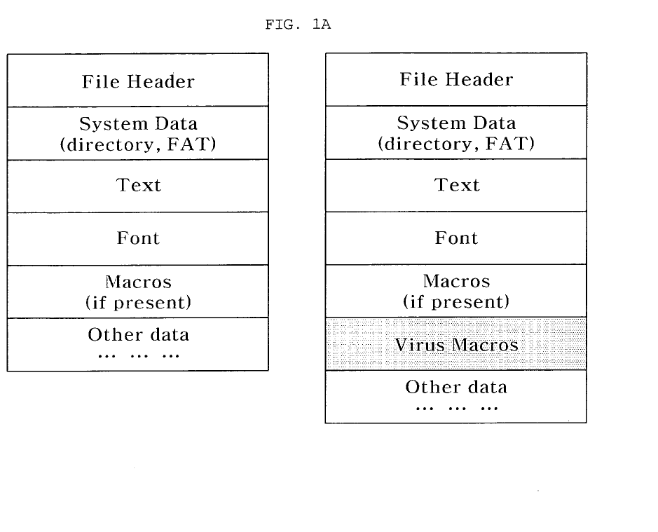

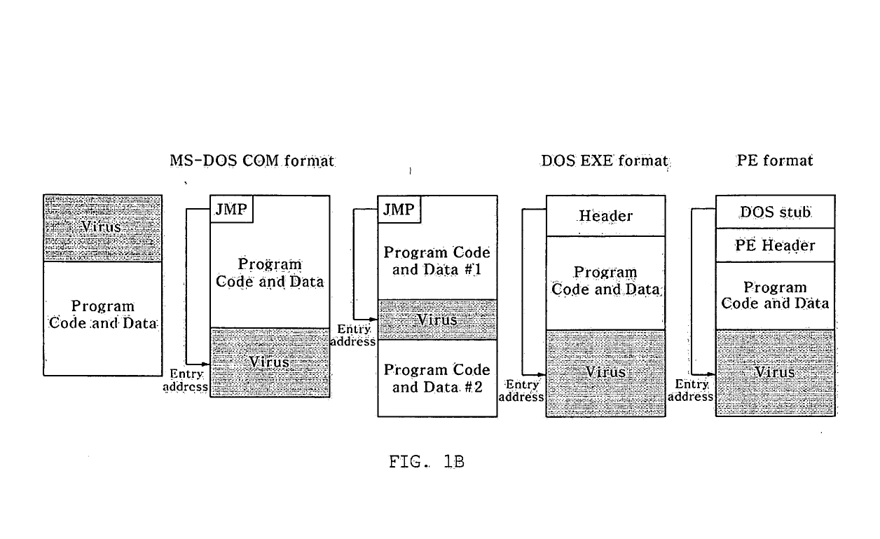

FIGS. 1A and 1B are views illustrating virus-infected parts of general and executable files, which are applied to an exemplary embodiment of the present invention.

Referring to FIG. 1A, this shows the case of the macro virus infection. A macro virus is inserted into a part where a macro enters a document file such as an MS Word file or an Excel file.

Referring to FIG. 1B, a virus is inserted into a COM or EXE file of MS-DOS or a portable executable (PE) file of Windows. In other words, the executable file is infected with the virus.

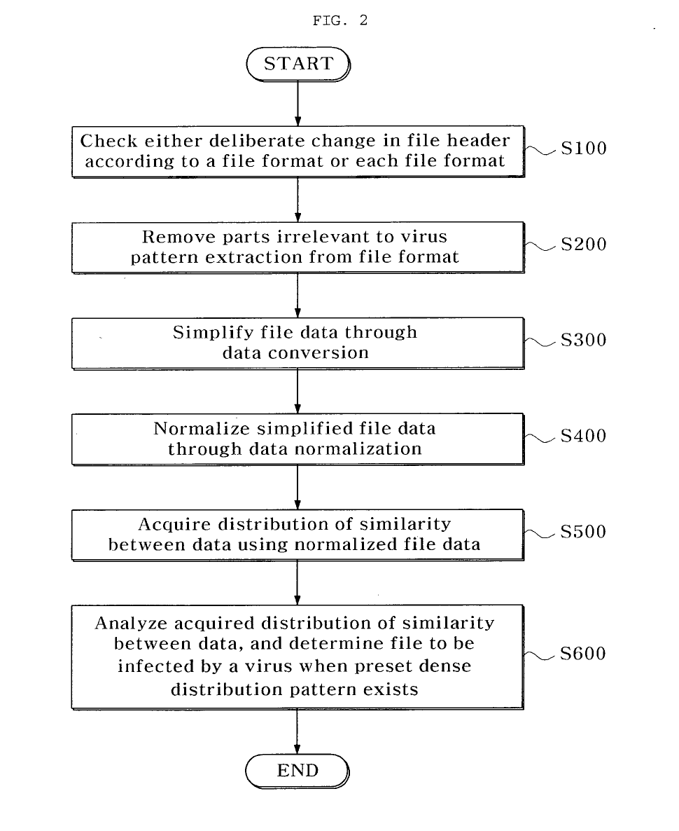

FIG. 2 is a schematic flow chart illustrating a method of detecting virus infection of a file according to an exemplary embodiment of the present invention.

Referring to FIG. 2, first, an original file is copied and read, and then it is checked according to file format whether or not a file header is deliberately changed, or each file format is checked. When a part changed by a virus is discovered before checking virus patterns, the file which has the changed part should be filtered as malicious one (S100).

Then, when the change in the file format is completely checked, parts irrelevant to extraction of the virus pattern are removed from the file format (S200). File data after removing irrelevant parts is simplified through data conversion (S300). At this time, the data conversion refers to conversion of binary format file data into short integer format file data.

Afterwards, the file data simplified in step S300 is normalized through data normalization (S400). In other words, the normalization refers to standardization of the simplified file data by converting it into data having a specific range (e.g. [0, 1]).

Subsequently, distribution of similarity between data is acquired using the file data normalized in step S400 (S500). The distribution of similarity between data is analyzed. Thereby, if a preset dense distribution pattern exists, it is determined that a corresponding file is infected with the virus (S600).

Here, the dense distribution pattern refers to a pattern in which the data are densely distributed around a certain point. The data infected with a virus shows this dense data distribution. Thus, it can be easily found based on the dense data distribution whether or not the data is infected with the virus.

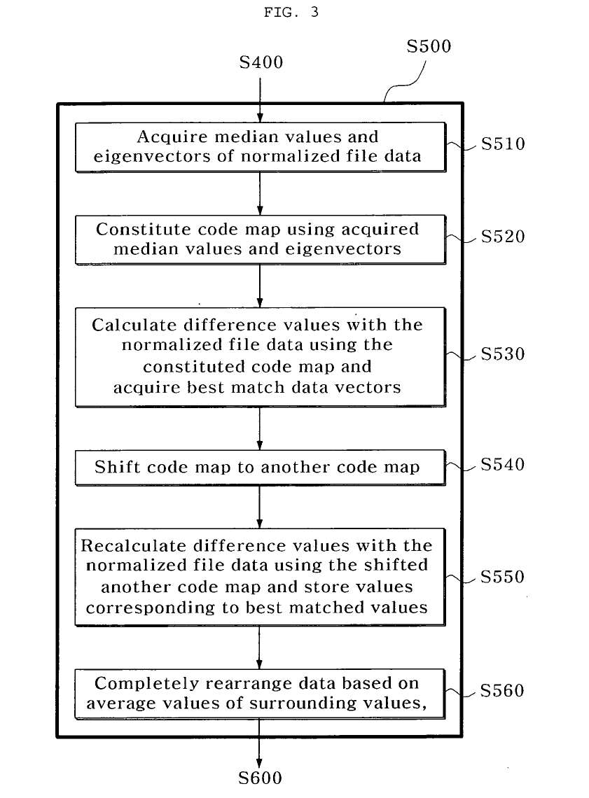

FIG. 3 is a detailed flow chart illustrating a method of acquiring distribution of similarity between data that is applied to an exemplary embodiment of the present invention.

Referring to FIG. 3, the distribution of similarity between data that is applied to an exemplary embodiment of the present invention can be acquired through a plurality of data calculation processes. More specifically, the distribution of similarity between data can be acquired by constituting a code map optimized for the similarity of the file data normalized in step S400 of FIG. 2 using a typical Self-Organizing Map (SOM) learning algorithm, and forming a new matrix on the basis of average values of surrounding values.

In detail, first, median values and eigenvectors of the normalized file data are acquired (S510), and then the code map is constituted using the acquired median values and eigenvectors (S520).

Afterwards, using the codemap generated in step 520, difference values with the normalized file data are calculated, thereby obtaining vectors that best match the normalized file data, i.e., best match data (step 530).

Subsequently, by the best match data vectors obtained in step 530, the codemap is changed into another map to recalculate all of the data (step 540). Then, difference values with the normalized file data are recalculated, and values corresponding to a small difference value, i.e., best-matched values, are mainly stored (step 550).

Subsequently, all of the data is reorganized on the basis of average values of surrounding values, thereby constructing a new matrix (step 560).

Meanwhile, the typical SOM leaning algorithm is applied in steps S510 through S550, and is disclosed in detail in well-known documents, [Teuvo Kohonen, “Self-Organization and Associative Memory,” 3rd edition, New York: Springer-Verlag, 1998] and [Teuvo Kohonen, “Self-Organizing Maps,” Springer, Berlin, Heidelberg, 1995].

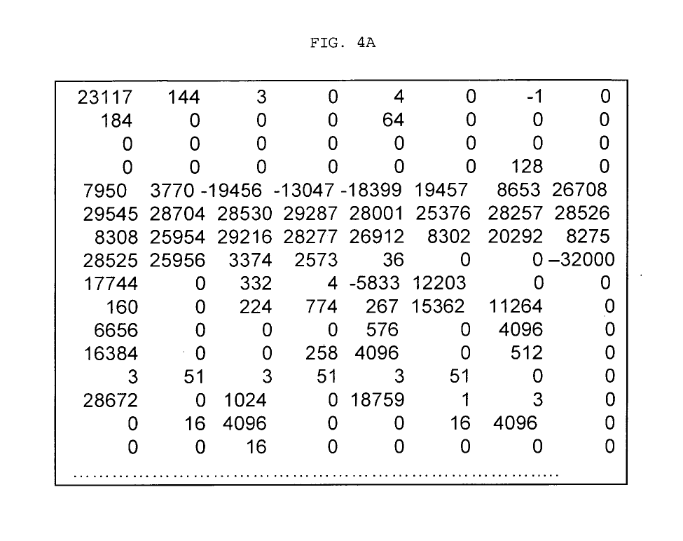

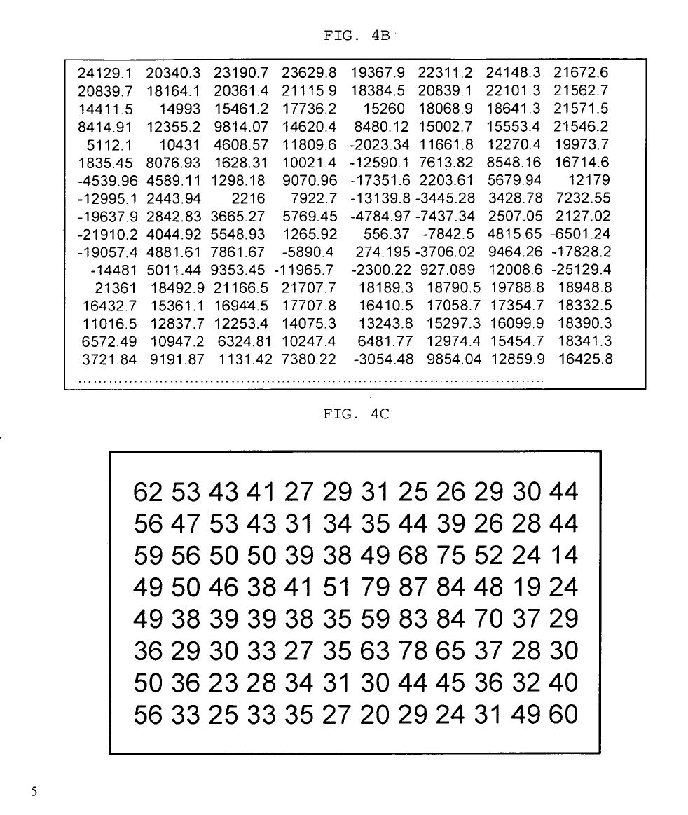

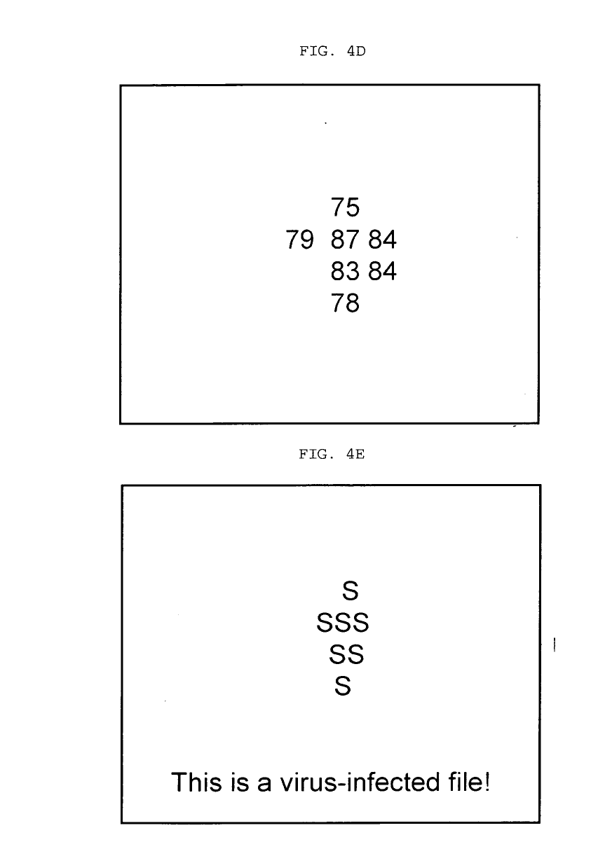

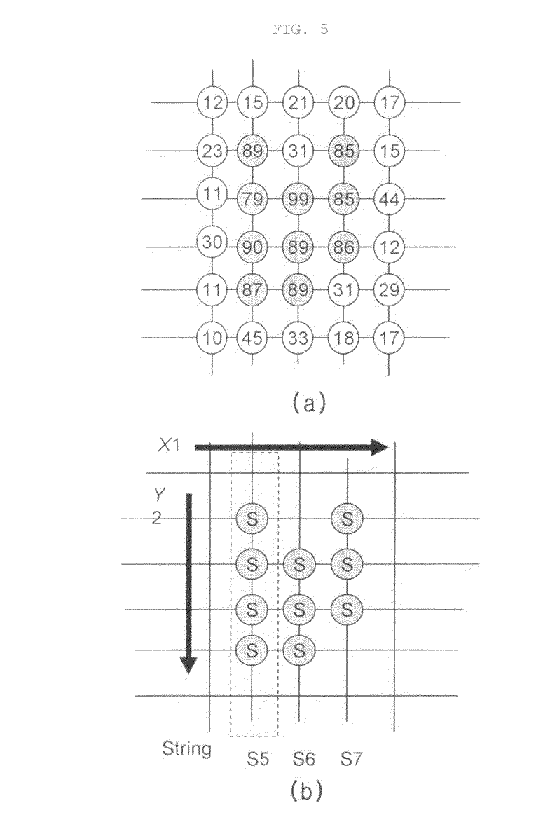

FIGS. 4A through 4E illustrate actual data of a virus-infected file that is determined by a method of detecting virus infection of a file according to an exemplary embodiment of the present invention. FIG. 4A illustrates a part of data that is converted from a binary format into a simple integer format. FIG. 4B illustrates a part of data after simplified file data is normalized. FIG. 4C illustrates a part of data that is acquired by constituting a new matrix after an SOM learning algorithm is performed on the data of FIG. 4B. FIG. 4D illustrates data that acquires distribution of similarity between data by leaving data values greater than a preset reference value (e.g. 72) among the data values acquired in FIG. 4C, and by removing the remaining data values. FIG. 4E illustrates data that are replaced with a character, “S,” so as to easily recognize the data acquired in FIG. 4D.

FIG. 5 illustrates actual data of a dense distribution pattern that is applied to an exemplary embodiment of the present invention. (a) and (b) of FIG. 5 correspond to FIGS. 4D and 4E. In (b) of FIG. 5, when a group of “S” characters is shown in the state where it is occupied by at least ¾ of a square, this can be determined as a “dense distribution pattern.”

Meanwhile, the “S” characters may cover the new matrix (this is shown when all analogies of data are similar to each other). This case is not determined as the dense distribution pattern although the “S” characters are collected at one place.

As described above, since the method of detecting virus infection of a file according to the present invention can determine by itself whether or not the file is infected with the virus without the virus signature DB, it can efficiently protect against a newly created virus.

Further, according to the present invention, the method of detecting virus infection of a file can be mounted on an e-mail server, an antivirus server, a desktop antivirus program, a mobile antivirus program, and so on to detect the virus, so that it can more safely protect computer systems against attack of the virus.

Meanwhile, the method of detecting virus infection of a file according to an exemplary embodiment of the present invention can be realized in computer readable media as computer readable codes. Here, the computer readable media include all types of recording devices in which computer readable data is stored.

Examples of the computer readable media include a read-only memory (ROM), a random access memory (RAM), a CD-ROM, a magnetic tape, a hard disk, a floppy disk, a mobile storage device, a non-volatile memory (flash memory), an optical data storage device, and so forth, and also include anything that is realized in the form of a carrier wave (e.g. transmission over the Internet).

Further, the computer readable media are distributed among computer systems connected through a computer communication network, and can be stored as a code that can be read in a distribution type to be executed.

As described above, according to the present invention, unlike an existing method of detecting the virus depending on information on virus signatures, the method of detecting virus infection of a file determines whether or not the file is infected with a virus by itself by finding a virus pattern using an artificial intelligent method based on the distribution of similarity between data without virus information, so that it can effectively process the virus for the purpose of prior protection before damage is caused by the virus. Further, the method can effectively detect a variant of the virus that has already caused damage, so that it can reduce damage resulting from this virus to the maximum extent.

Further, according to the present invention, the method does not need the virus signature DB, so that it is not required to update the DB from a server to a client per day. For example, the method can be applied to all of a mail server, a desktop or laptop computer, a mobile device (smart phone, PDA phone, etc.), IPTV, and an electronic product connected to a network.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of detecting virus infection of a file, comprising the steps of:
a) copying an original file, and converting and simplifying data of the copied file;
b) normalizing the simplified file data;
c) acquiring distribution of similarity between data using the normalized file data; and
d) analyzing the acquired distribution of similarity between data, and determining that the file is virus-infected when a preset dense distribution pattern exists.

2. The method as set forth in claim 1, wherein step a) includes checking according to a format of the copied file whether or not a file header is deliberately changed prior to converting and simplifying the data of the copied file.

3. The method as set forth in claim 1, wherein step a) includes checking a format of the copied file prior to converting and simplifying the data of the copied file, and determining that the file is virus-infected when a part changed deliberately by the virus exists.

4. The method as set forth in claim 1, wherein in step a), the data conversion is performed by converting binary format file data into simple integer format file data.

5. The method as set forth in claim 1, wherein the original file includes one of a general file and an executable file.

6. The method as set forth in claim 1, wherein the original file already exists in a user terminal or is received from an outside source through a specific path.

7. The method as set forth in claim 6, wherein the user terminal includes one selected from a desktop computer, a laptop computer, a personal digital assistant (PDA), a mobile phone, a WebPDA, and a transmission control protocol (TCP) networking assisted wireless mobile device.

8. The method as set forth in claim 6, wherein the specific path includes one selected from Internet, e-mail, Bluetooth, and ActiveSync.

9. The method as set forth in claim 1, wherein step b) includes converting the simplified file data into data having a specific range when standardized.

10. The method as set forth in claim 1, wherein in step c), the distribution of similarity between data is acquired by constituting a code map optimized for the normalized file data using a typical Self-Organizing Map (SOM) learning algorithm, and forming a new matrix on the basis of average values of surrounding values.

11. The method as set forth in claim 1, wherein step c) includes the sub-steps of:
c-1) acquiring median values and eigenvectors of the normalized file data, and constituting a code map using the acquired median values and eigenvectors;
c-2) calculating difference values with the normalized file data using the constituted code map, and acquiring best match data vectors;
c-3) shifting the code map to another code map in order to calculate whole data once again using the acquired best match data vectors, recalculating difference values with the normalized file data using the shifted another code map, and storing values corresponding to best matched values; and
c-4) rearranging the data on the basis of the average values of the surrounding values, and forming a new matrix.

12. A computer readable medium recording a program that can execute the method as set forth in any one of claims 1 through 11 using a computer.
